(19) United States
(12) Patent Application Publication
(10) Pub. No.: US 2006/0018380 A1
(43) Pub. Date: Jan. 26, 2006

(54) Motion estimation method for video encoding

(75) Inventors: Yu-Chung Chang, Taipei City (TW); Pei-Yun Kuo, Hsinchu City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: Mediatek Incorporation

(21) Appl. No.: 11/185,504

(22) Filed: Jul. 20, 2005

(30) Foreign Application Priority Data
Jul. 20, 2004 (TW) 93121668

(51) Int. Cl. H04N 11/02; H04N 7/12; H04N 11/04; H04B 1/66

(52) U.S. Cl. 375/240.16; 375/240.24; 375/240.12

(57) ABSTRACT

A motion estimation method for generating a motion vector to encode a original block includes: (a0) generating a center point (CTP); (a) generating a main search window (MSW) around the CTP, which has a step size of 3 and 7×7 points, calculating BDMs corresponding to CPs (check points) in MSW, and setting CP corresponding to a minimum BDM as a candidate CP (CCP); (a1) judging whether CCP is CTP, and executing step (c) if yes, otherwise executing step (b); (b) setting CCP as CTP and executing step (a); and (c) generating an auxiliary search window (ASW) around the CCP, which has a step size of 1 and 3×3 points, and calculating BDMs corresponding to CPs in ASW, wherein one of CPs corresponding to a minimum BDM in ASW is an optimum point, and subtracting coordinates of CTP from those of the optimum point so as to obtain the motion vector.

This application claims the benefit of Taiwan application Serial No. 93121668, filed Jul. 20, 2004, the subject matter of which is incorporated herein by reference.

### BACKGROUND OF THE INVENTION

1. Field of the Invention

The invention relates in general to a motion estimation method, and more particularly to a motion estimation method in a video encoding process.

2. Description of the Related Art

In the technology of motion compensation for video encoding, a motion vector is generated according to a previous frame and then is used to encode a current frame. The motion vector may be generated by a motion estimation method. The typical motion estimation method takes one block (macroblock) of each frame as a minimum estimation unit, and the size of each block is, for example, 16×16 pixels.

FIG. 1 is a schematic illustration showing a conventional motion compensation for video encoding. When a block 104 of a current frame 102 is to be encoded, a block 108, which most matches with the block 104 and has the minimum distortion relative to the block 104, in a search window 110 of a previous frame 106 has to be found by using a motion estimation method. Then, the differences between the coordinate values of the block 108 in the frame 106 and those of the block 104 in the frame 102 are calculated to obtain a motion vector 112. Next, the distortion between the image data of the block 104 and the image data of the block 108 is encoded. Compared to the method for encoding the block 104 of the frame 102 directly, using the motion compensation for video encoding can greatly reduce the data quantity to be transmitted for the image data of the frame 102, and the image data of the frame 102 can be effectively compressed.

There are two conventional motion estimation algorithms that have been disclosed. The first algorithm is a TSS (Three-Step Search) algorithm disclosed by T. Koga, K. Iinuma, A. Hirano, Y. Iijima and T. Ishiguro in “Motion-Compensated Interframe Coding for Video Conferencing”, Proc. NTC81, New Orleans, La., November 1981, and the second algorithm is a FSS (Four-Step Search) algorithm disclosed by Lai-Man Po and Wing-Chung Ma in “A Novel Four Step Search Algorithm For Fast Block Motion Estimation”, IEEE Transactions on Circuits and Systems for Video Technology, vol. 6, no. 3, June 1996.

FIG. 2 is a schematic illustration showing a conventional TSS (Three-Step Search) algorithm. The TSS algorithm totally has three steps of search operations, and the step sizes SS of the three steps are respectively 4, 2 and 1 pixel length(s). The steps are described as follows. First, a square search window 204 is taken. Each side of the square search window 204 has 9 points, and the size of the search window 204 is 9×9 points. Three equally spaced points among the 9 points at each side are taken as check points, and also, a center point of the search window 204 is further taken as a check point 202(1). The side length of the search window 204 equals 8 pixel lengths, and the distance between each check point and its adjacent check point equals 4 pixel lengths. So, the step size SS of the search window 204 equals 4 pixel lengths. Next, block distortion measure (BDM) corresponding to each check point is determined, and the check point, the check point 202(2), corresponding to the minimum block distortion measure is found. Then, 9 check points on a search window 206, defined by taking the check point 202(2) as the center and 4 pixel lengths as the side length, are taken, and the check point, the check point 202(3), corresponding to the minimum block distortion measure is found. Finally, 9 check points on a search window 208, defined by taking the check point 202(3) as the center and 2 pixel lengths as the side length are taken, and the check point, the check point 202(4), among the 9 check points, corresponding to the minimum block distortion measure is calculated and determined. Thus, the value of the motion vector 210 may be obtained according to the check points 202(4) and 202(1).

In the TSS algorithm, a block matching operation has to be performed 25 times separately for the 25 blocks corresponding to the 25 check points. That is, 25 block distortion measures have to be calculated. The positions, where the check points may appear, determine a search region 200, and the search region 200 of the TSS algorithm is ±7.

Each check point corresponds to one block of the previous frame, and the points at different positions correspond to the blocks at different positions. For example, FIGS. 3A and 3B respectively show blocks 302(1) and 302(2) corresponding to check points 202(1) and 202(2). Because the check point 202(2) may be obtained by shifting the check point 202(1) rightward and upward by four pixels, the region range of the block 302(2) may be obtained by shifting the region range of the block 302(1) rightward and upward by four pixels. Taking the check point 202(2) as an example, the block distortion measure of the check point 202(2) is calculated by summing up all of the absolute values of the differences between the image data values of all pixels of the block 302(2) and the corresponding image data values of all pixels of the block corresponding to the center point of the search region 200 in the current frame.

FIG. 4 is a schematic illustration showing a conventional FSS (Four-Step Search) algorithm. The FSS algorithm totally has four steps of search operations, and the step sizes SS of the steps are respectively 2, 2, 2 and 1 pixel length(s). The steps are described in the following. First, the center point of the search region 400 is taken as the center, and then 9 check points 402 are obtained. The distance between each check point 402 and its adjacent check point 402 is 2 pixel lengths, wherein the check point 402(1) is at the center point. Next, the block distortion measure corresponding to each check point 402 is determined, and the check point, the check point 402(2), corresponding to the minimum block distortion measure is found. Then, the above-mentioned steps are repeated twice so that the check points 402(3) and 402(4) are determined respectively. Finally, the check point having the minimum block distortion measure among the 8 check points which are adjacent to the check point 402(4) is determined. The check point with the minimum block distortion measure is the determined optimum point, and the motion vector is obtained by subtracting the coordinates of the center point from the coordinates of the optimum point. The search region of the FSS algorithm is also ±7.

The FSS algorithm has the early termination function. That is, in any of the three former steps of search operations, if the check point corresponding to the minimum block distortion measure is at the center point, the fourth step of search operation will be performed immediately following that step, and the calculation of the FSS algorithm is completed. Thus, the block matching process has to be performed from 17 (=9+8) to 27 (=9+5+5+8) times. The calculating time for the FSS algorithm is shorter than that for the TSS algorithm on average.

The FSS algorithm is mainly designed on the basis of the property of the center-biased distribution of the motion vector. The FSS algorithm processes the slow motion images in a more effective manner than the TSS algorithm. The so-called center-biased distribution represents that the images in the actual daily life change in a slow and smooth manner. Thus, the opportunity of finding the check point having a minimum block distortion measure around the center point of the search window is very high. However, when the FSS algorithm is used for encoding a fast motion image, the PSNR (Peak Signal-to-Noise Ratio) representative of the picture quality relatively decreases. The main reason is the step sizes of the former three steps of search operations of the FSS algorithm are a constant of 2, the sizes of the search windows are 5×5, and the search window for the fourth step of search operation is 3×3. Thus, when the image moves fast, the step size of 2 is not large enough and cannot catch up with the moving speed of the image. In addition, when the block distortion measure of some check point of the search window has the property of local minimum, the search region cannot be substantially and effectively increased even though the number of search steps is increased, for example, the FSS is extended to be n steps of search (n>4). The local minimum occurs in the condition described as follows. In the searched nine check points, when the block distortion measure corresponding to the check point at the center point is the minimum, the condition for the early termination will be satisfied, and the final step is directly and immediately performed. That is, the FSS algorithm may erroneously regard a minimum in one local small region as the global minimum in the whole search region. Thus, the image quality after the encoding and compression is deteriorated.

Therefore, it is an important subject in the related industry to enhance the image quality after compression, especially the image quality of the fast motion images after compression.

### SUMMARY OF THE INVENTION

It is therefore an object of the invention to provide a motion estimation method for video encoding, wherein the method can effectively enhance the image quality after compression, especially the image quality of the fast motion images after compression. The invention can further achieve the object of decreasing the search time, and reducing the image distortion after compression.

The invention achieves the above-identified object by providing a motion estimation method for video encoding. When encoding an original block of a current frame, the method searches a target block in a previous frame that most matches with the original block. The method generates a motion vector required for encoding the original block according to relative positions of the target block and the original block. The target block is one of a plurality of blocks B(I, J) corresponding to a plurality of points CP(I, J) contained in a search region, and I and J are integers. The motion estimation method includes the steps of: (a) setting parameters as K=0, L=0, P=1; (b) setting a P-th main search window, which has a plurality of check points comprising points CP(M, N), wherein M=K+i, N=L+j, i, j=−3, 0, 3, calculating a plurality of block distortion measures BDM(M, N) of the blocks respectively corresponding to the check points of the P-th main search window, and defining a minimum one among the block distortion measures as BDM(K+s, L+t), wherein s and t are integers; (c) determining whether P equals a main predetermined number of step, and executing step (f) if yes, otherwise executing step (c1); (c1) judging whether s=t=0, and executing step (f) if yes, otherwise executing step (d); (d) adding s to K, adding t to L, adding 1 to P, and executing step (b); and (f) setting an auxiliary search window, which has a plurality of check points comprising points CP(M′, N′), wherein M′=K+u, N′=L+v, u, v=−1, 0, 1, calculating a plurality of block distortion measures BDM(M′, N′) of the blocks respectively corresponding to the check points of the auxiliary search window, and selecting the block corresponding to a minimum one among the block distortion measures as the target block.

The invention also achieves the above-identified object by providing a motion estimation method for video encoding. The method generates a motion vector required for encoding an original block when encoding the original block of a current frame. The method includes the steps of: (a0) generating a center point; (a) executing a first step of search operation having a step size of 3, wherein a first main search window having 7×7 points is generated round the center point, a plurality of block distortion measures respectively corresponding to a plurality of check points in the first main search window are calculated, and the check point corresponding to a minimum one among the block distortion measures is set as a candidate check point; (a1) determining whether the candidate check point is the center point of the first main search window, and executing step (d) if yes, otherwise executing step (b); (b) setting the candidate check point as the center point and executing a second step of search operation with a step size of 3, wherein a second main search window having 7×7 points is generated around the center point, multiple block distortion measures respectively corresponding to multiple check points in the second main search window are calculated, the check point corresponding to a minimum one among the block distortion measures in the second step of search operation is set as the candidate check point; (b1) determining whether the candidate check point is the center point of the second main search window, and executing step (d) if yes, otherwise executing step (c); (c) executing a third step of search operation having a step size of 3, wherein a third main search window having 7×7 points is generated around the candidate check point, a plurality of block distortion measures respectively corresponding to a plurality of check points in the third main search window are calculated, and the check point corresponding to a minimum one among the block distortion measures in the third step of search operation is set as the candidate check point; and (d) executing a last step of search operation having a step size of 1, wherein an auxiliary search window having 3×3 points is generated around the candidate check point, multiple block distortion measures respectively corresponding to multiple check points in the auxiliary search window are calculated, the check point corresponding to a minimum one among the block distortion measures in the last step of search operation is set as the candidate check point, and the motion vector is obtained by subtracting coordinates of the original center point generated in the step (a0) from coordinates of the candidate check point set in the step (d).

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1 is a schematic illustration showing a conventional motion compensation for video encoding.

FIG. 2 is a schematic illustration showing a conventional TSS (Three-Step Search) algorithm.

FIGS. 3A and 3B respectively show blocks 302(1) and 302(2) corresponding to check points 202(1) and 202(2).

FIG. 4 is a schematic illustration showing a conventional FSS (Four-Step Search) algorithm.

FIG. 5 is a flow chart showing a motion estimation method for video encoding according to a preferred embodiment of the invention.

FIG. 6A shows a first example of the motion estimation method for video encoding in this embodiment.

FIG. 6B shows a second example of the motion estimation method for video encoding in this embodiment.

FIG. 7 shows another example of a conventional FSS algorithm.

FIG. 8 shows another example of the motion estimation method for video encoding in this embodiment.

FIG. 9 is a schematic illustration showing a 4-4-2-1 algorithm.

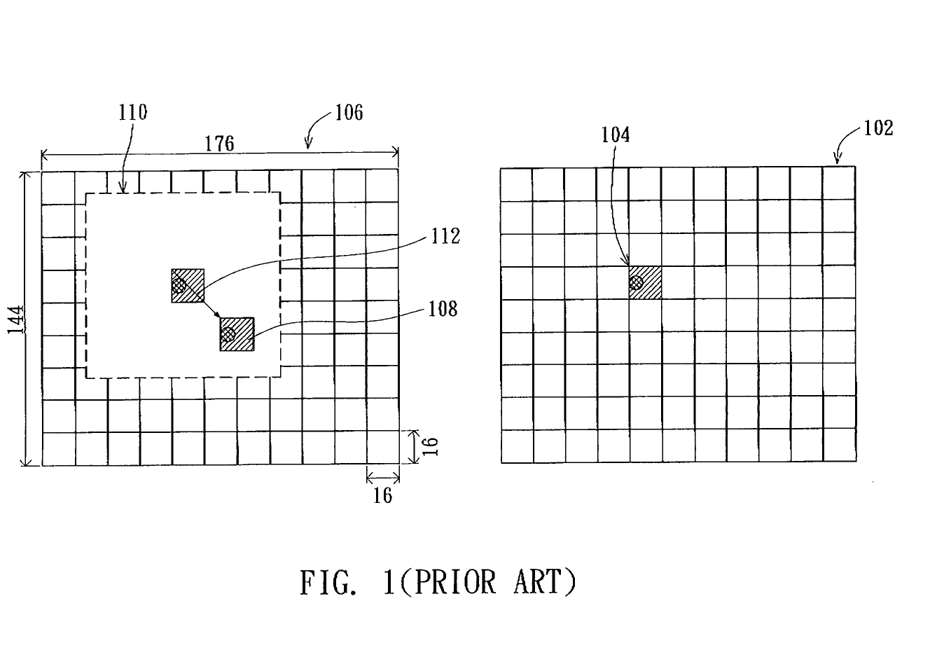

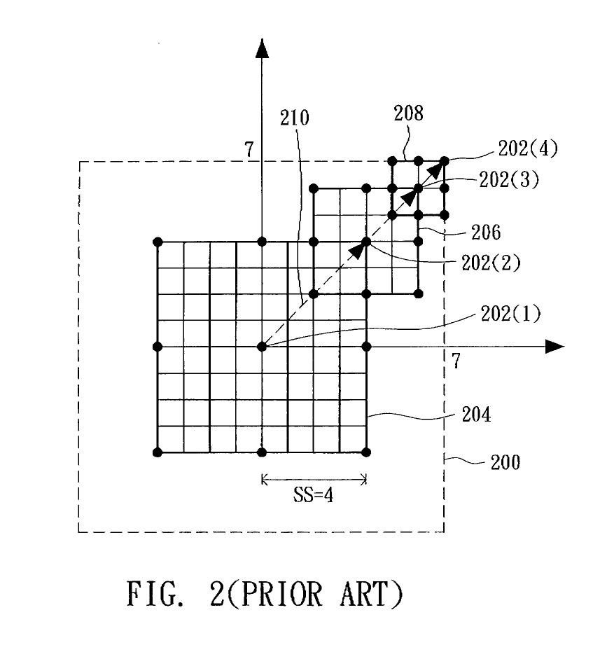

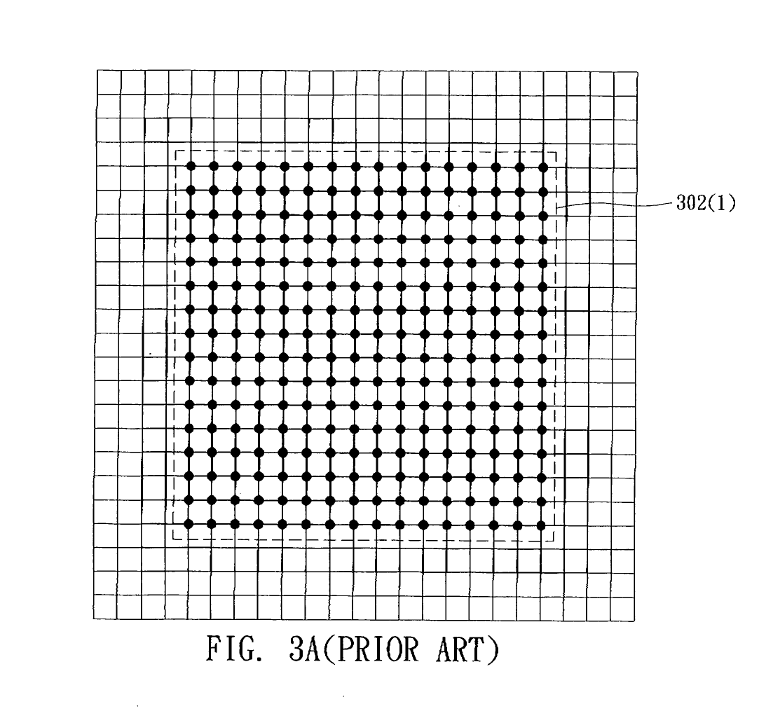

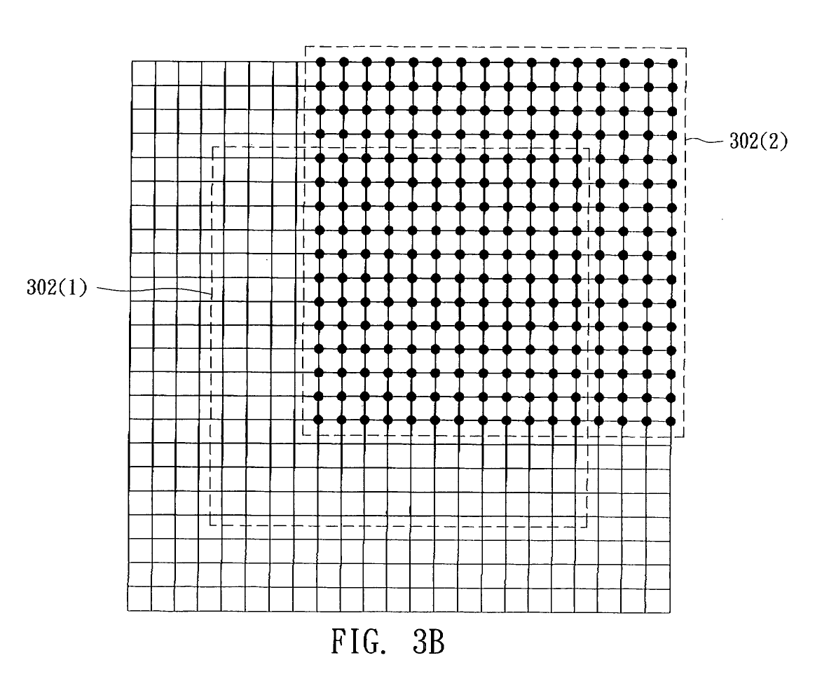

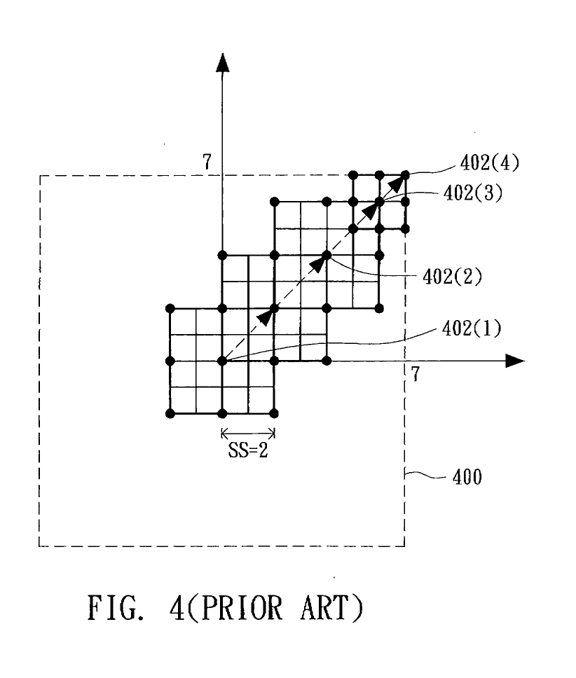

### DETAILED DESCRIPTION OF THE INVENTION

The motion estimation method for video encoding according to the invention can effectively enhance the PSNR of the fast motion image after compression. By applying the present invention, as for the fast motion image after compression, the PSNR can be increased by about 0.2 to 0.4 dB as compared to the conventional FSS algorithm. As for the slow motion image or still image after compression, the image quality close to that of the FSS algorithm can be reached. In addition, the average calculation speed of the method according to the invention is faster than that of the FSS algorithm and that of the TSS algorithm.

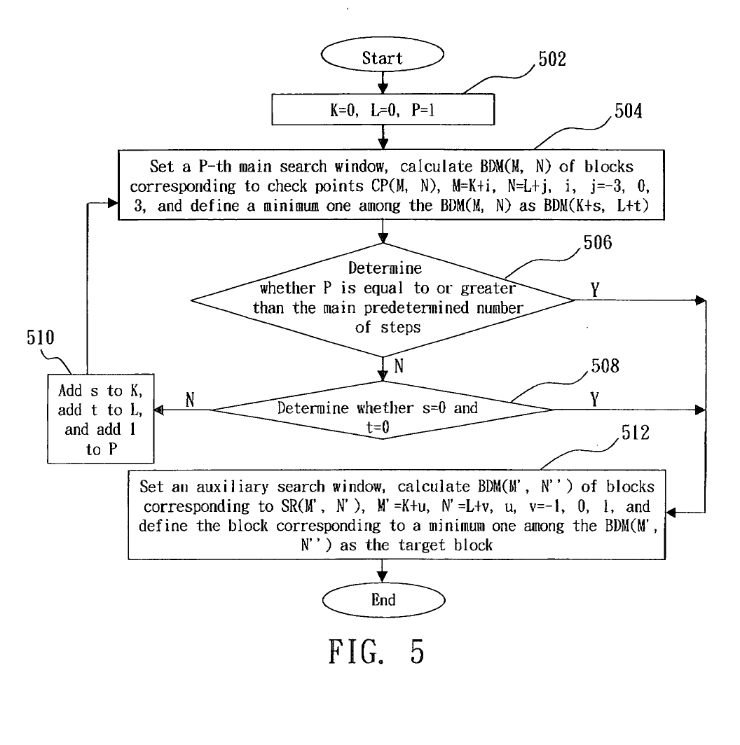

FIG. 5 is a flow chart showing a motion estimation method for video encoding according to a preferred embodiment of the invention. In order to encode an original block of a current frame, the method of this embodiment searches a target block, which most matches with the original block, in a previous frame. The method of this embodiment then generates a motion vector, which is required to encode the original block, according to relative positions of the target block and the original block. The target block is one of multiple blocks B(I, J) corresponding to multiple points CP(I, J) contained in a search region, wherein I and J are integers. The motion estimation method of this embodiment mainly includes steps 502 to 512, which are described in the following.

First, step 502 is performed. A center point of the window is set to have a horizontal coordinate parameter K=0 and a vertical coordinate parameter L=0, and the step number P=1. Next, step 504 is performed to set a P-th main search window which has multiple check points, including points CP(M, N), wherein M=K+i, N=L+j, i, j=−3, 0, 3. In this step, multiple block distortion measures BDM(M, N) of multiple blocks respectively corresponding to the check points of the P-th search window are calculated. A minimum one among the block distortion measures is defined as BDM(K+s, L+t), wherein s and t are integers.

Then, step 506 is performed to determine whether P equals a main predetermined number of steps. If yes, step 512 is performed, otherwise step 508 is performed. In step 508, it is determined whether s=0 and t=0. If yes, step 512 is performed, otherwise step 510 is performed. In step 510, s is added to K, t is added to L, 1 is added to P, and step 504 is performed.

In step 512, an auxiliary search window is set. The auxiliary search window has multiple check points including points CP(M′, N′), wherein M′=K+u, N′=L+v, u, v=−1, 0, 1. In this step, multiple block distortion measures BDM(M′, N′) of the blocks respectively corresponding to the check points of the auxiliary search window are calculated. A block corresponding to a minimum one among the block distortion measures is defined as a target block.

The center point CP(0, 0) of the search region corresponds to the block B(0, 0), which is located at the same position as the original block, in the previous frame. In step 504, the block distortion measure for one block is calculated by summing up the absolute values of the differences between the image data of all pixels of the block of the previous frame corresponding to the check point and the corresponding image data of all pixels of the original block. The main predetermined number of step is a positive integer greater than or equal to 1, and is preferably equal to 3.

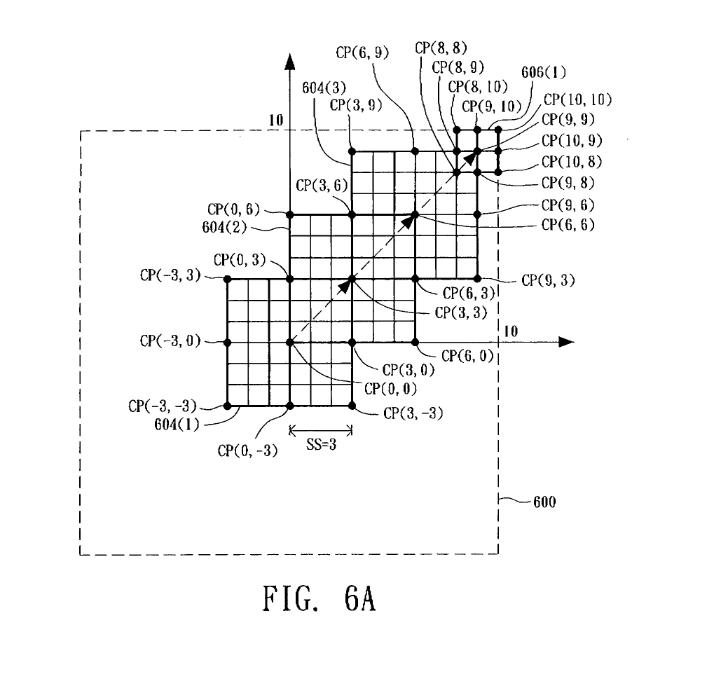

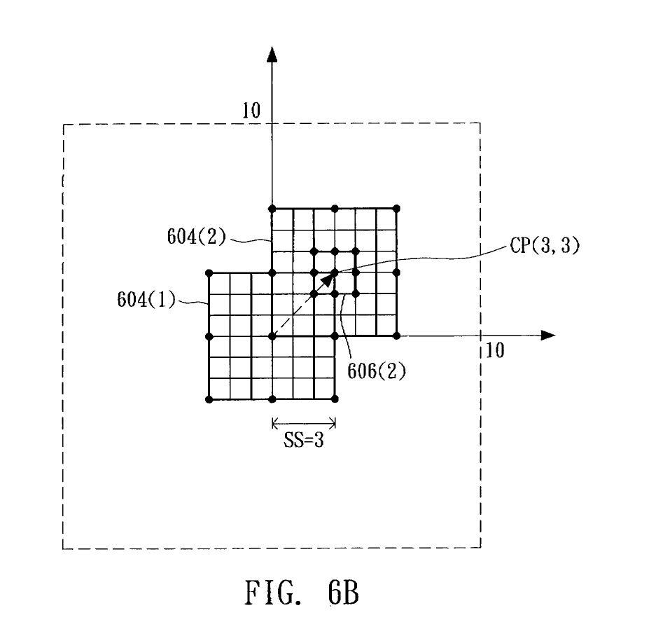

An example will be described in the following. FIG. 6A shows a first example of the motion estimation method for video encoding in this embodiment. In the first example, the main predetermined number of step is set as 3, and the total number of search step is set as 4. The search region 600 is ±10 and includes 11×11 points CP(I, J), wherein −10<=I<=10, −10<=J<=10. The step size SS of each of the first to third steps of search operation is 3, and the first, second and third main search windows 604(1), 604(2) and 604(3), each of which has 7×7 points, are respectively applied in the first to third steps of search operation. Each main search window has 9 check points, and the distance between two adjacent check points equals 3 pixel lengths. The step size SS of the last step of search operation is 1, and an auxiliary search window 606(1) having 3×3 points is applied in the last step of search operation. The auxiliary search window 606(1) also has 9 check points, and the distance between two adjacent check points equals 1 pixel length.

First, step 502 is performed to set K=0, L=0, P=1, and step 504 is performed. The first main search window 604(1) has 9 check points including points CP(0, 0), CP(0, 3), CP(0, −3), CP(−3, 0), CP(−3, 3), CP(−3, −3), CP(3, 0), CP(3, 3) and CP(3, −3). If the block distortion measure BDM(3, 3) corresponding to the check point CP(3, 3) is the minimum, it is set that BDM(3, 3)=BDM(K+s, L+t), and the check point CP(3, 3) is set as a candidate check point. Because K=L=0, it is obtained that s=3 and t=3. Because P=1<3, s=3 and t=3, step 510 is then performed to add 3 to K, add 3 to L, and add 1 to P.

At this time, K=L=3 and P=2. Next, step 504 is performed repeatedly to calculate 9 block distortion measures separately corresponding to 9 check points, including points CP(3, 3), CP(3, 6), CP(3, 0), CP(0, 3), CP(0, 6), CP(0, 0), CP(6, 3), CP(6, 6) and CP(6, 0), on the second main search window 604(2). The second main search window 604(2) takes the candidate check point (i.e., the check point CP(3, 3)) as the center point. If the block distortion measure BDM(6, 6) corresponding to the check point CP(6, 6) is the minimum, it is set that BDM(6, 6)=BDM(K+s, L+t), and the check point CP(6, 6) is set as the candidate check point. Because K=L=3, it is obtained that s=3 and t=3. Similarly, because P=2<3, s=3 and t=3, step 510 is then performed to add 3 to K, add 3 to L, and add 1 to P.

At this time, K=L=6 and P=3. Next, step 504 is performed repeatedly to calculate 9 block distortion measures corresponding to 9 check points on the third main search window 604(3). The third main search window 604(3) takes the candidate check point (i.e., the check point CP(6, 6)) as the center point. If the block distortion measure BDM(9, 9) corresponding to the check point CP(9, 9) is the minimum, it is set that BDM(9, 9)=BDM(K+s, L+t), and the check point CP(9, 9) is set as the candidate check point. Because K=L=6, it is obtained that s=3 and t=3. Thereafter, step 506 is performed. Because P=3, step 512 is then performed.

In step 512, the auxiliary search window 606(1) has 9 check points including points CP(9, 9), CP(9, 10), CP(9, 8), CP(8, 9), CP(8, 10), CP(8, 8), CP(10, 9), CP(10, 10) and CP(10, 8). The auxiliary search window 606(1) takes the candidate check point (i.e., the check point CP(9, 9)) as the center point. In this step, 9 check points correspond to 9 block distortion measures. The block corresponding to the minimum block distortion measure is selected to be the target block so that the motion vector may be determined. The motion vector is formed by subtracting the coordinates of the check point CP(9, 9) corresponding to the minimum block distortion measure and the coordinates of the original point, CP(0, 0).

This embodiment further has the early termination function. In any of the former three steps of search operation, if the check point corresponding to the minimum block distortion measure is located at the center point, the last step of search operation will be performed immediately following to that step. FIG. 6B shows a second example of the motion estimation method for video encoding in this embodiment. In the step 504, 9 block distortion measures corresponding to 9 check points on the second main search window 604(2) are calculated. Then, if the block distortion measure BDM(3, 3) corresponding to the check point CP(3, 3) is the minimum, it is set that BDM(3, 3)=BDM(K+s, L+t). Because K=L=3, it is obtained that s=0 and t=0. In the following steps 506 and 508, because s=t=0, the candidate check point will be the center point of the second main search window 604(2). Therefore, the step 512 is performed, and the last step of search operation is then performed.

That is, when any of the former three steps of search operation is completed and if the block distortion measure corresponding to the check point, which is located at the center point of the search window, is the minimum, the early termination will occur, the step size will change from 3 to 1, and the last step of search operation will be performed. If the block distortion measure corresponding to one of the 8 check points other than the center point of the search window is the minimum, the center point of the search window in the next step of search operation is set to that check point, and the next step of search operation is performed analogically.

Of course, it should be noted that the invention may be designed not to have early termination function. Thus, the invention is a search method having four search steps, wherein the step sizes of the four search steps are 3, 3, 3 and 1, respectively. In the former three search steps, the search window has 7×7 points. In the fourth search step, the search window has 3×3 points.

It is assumed that the image motion in the actual life is continuous, so the search windows of two adjacent steps of search operation of this embodiment are connected to each other, as shown in FIG. 6A. In each step of search operation, the moving process of the search window is continuous, which means that no point is omitted. The search region of this method is ±10, which is greater than that of ±7 in the FSS and TSS algorithms. So, by applying the present invention, the fast motion image can be caught and the possibility of obtaining a better motion vector will be increased, enhancing the image quality after compression. The number of points required to be searched in this embodiment ranges from 17 to 27.

The above-mentioned embodiment is described by using the example, where the predetermined number of step is 4 and the step sizes of the 4 steps are respectively 3, 3, 3 and 1 pixel length(s), but the invention is not limited thereto. According to the search range and the complexity of calculation, the invention can be designed to have N search step(s), wherein N is any integer greater than 1.

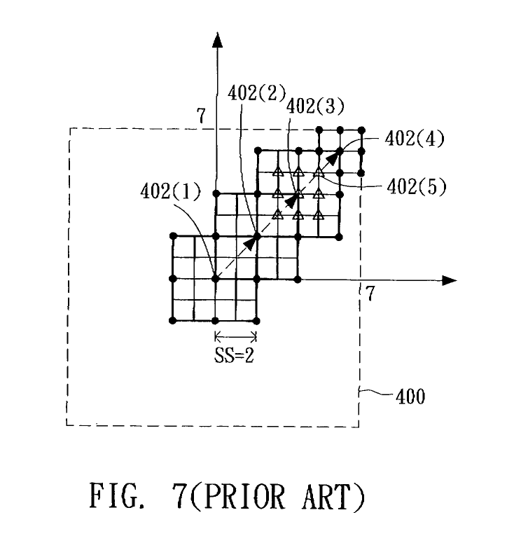

FIG. 7 shows another example of a conventional FSS algorithm. Although the search range of the conventional FSS algorithm can cover all points in the search region, overlapping occurs among search ranges. For example, if the check point corresponding to the minimum block distortion measure is the point 402(4) in the search region of the third step of search operation, the center point for the next step of search operation is moved to the point 402(4). Hence, to-be-searched points in the fourth step of search operation are around the point 402(4). If the check point corresponding to the minimum block distortion measure is the point 402(3) in the third step of search operation, the center point for the next step of search operation is moved to the point 402(3). Hence, the to-be-searched points in the fourth step of search operation are around the point 402(3), i.e., the points denoted by triangles in FIG. 7. As shown in FIG. 7, the search window with the center point of the point 402(4) and the search window with the center point of the point 402(3) are partially overlapped with each other, i.e. overlapped at point 402(5).

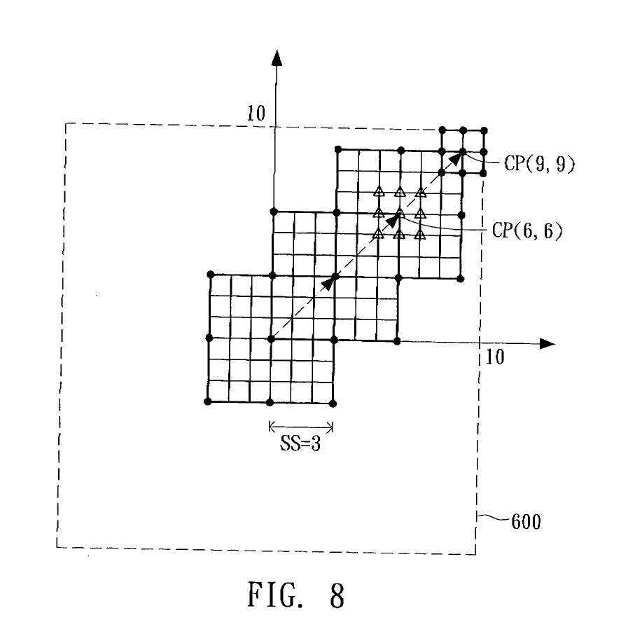

FIG. 8 shows another example of the motion estimation method for video encoding in this embodiment. If the check point corresponding to the minimum block distortion measure is the point CP(9, 9) or CP(6, 6) in the third step of search operation, the center point of the next step of search operation will be moved to the point CP(9, 9) or CP(6, 6). As a result, the to-be-searched points in the fourth step of search operation are around the point CP(9, 9) or point CP(6, 6). As shown in FIG. 8, the points around the point CP(9, 9) and the points around the point CP(6, 6) have no overlapping such that the search window having the center point of the point CP(9, 9) and the search window having the center point of the point CP(6, 6) have no overlapping, and the two search windows are continuous without any point being omitted. Obviously, the motion estimation method for video encoding in this embodiment has greater search range and has no point in the search region omitted.

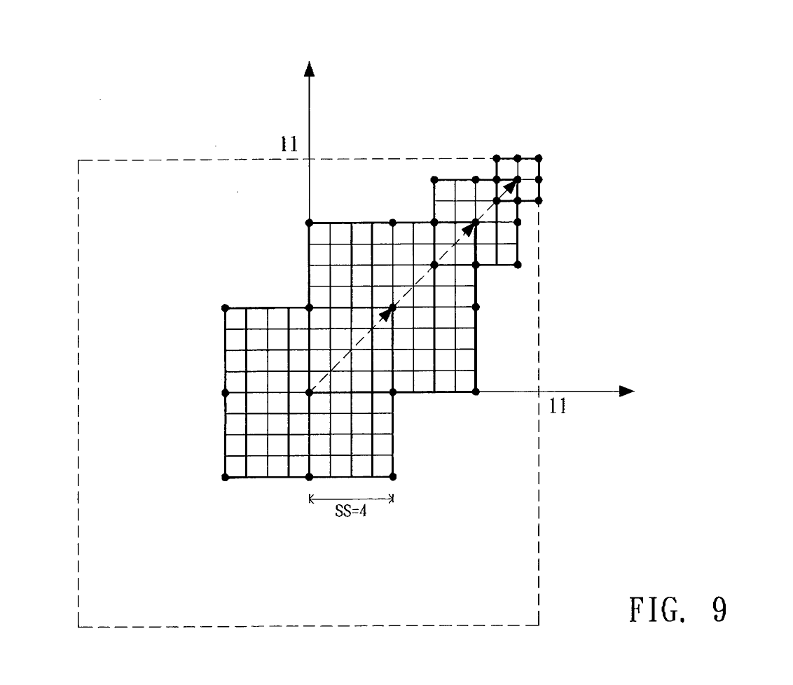

In addition, the effect of the invention still cannot be achieved even if the first step of search operation of the conventional FSS algorithm is simply repeated twice for having a greater search region. The algorithm is called as a 4-4-2-1 algorithm. FIG. 9 is a schematic illustration showing a 4-4-2-1 algorithm. In the 4-4-2-1 algorithm, the step size of the first and second steps of search operation is 4, the step size of the third step of search operation is 2, and the step size of the last step of search operation is 1 Therefore, the size of the search region is ±11. Although the search region for the 4-4-2-1 algorithm is large, the 4-4-2-1 algorithm does not have the early termination function, and the block matching operation has to be performed 34 times. Thus, the calculation time for the 4-4-2-1 algorithm is longer than those for the FSS algorithm and the method of this embodiment. More particularly, the search window for the first and second steps of search operation is too large (9×9), making the t check point pattern too sparse, and therefore, the search path tends to be directed to the error direction, and it tends to occur that the block distortion measure corresponding to the check point is the local minimum. Thus, the image compression effect is worse than that of the FSS algorithm.

It should be noted that, in the present invention, in addition to the last step of search operation, the number of former steps of the search operation, where the main search window having 7×7 points is applied, may be n, which is a positive integer greater than or equal to 1. The motion estimation method for video encoding according to the present invention may be applied for encoding an image signal to be transmitted or to be received by a mobile phone. The invention can effectively enhance the image quality of the compressed image, especially the image quality of the fast motion image after compression. The required search time of this invention is decreased, and the image distortion after compression is reduced.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A motion estimation method for video encoding, wherein when encoding an original block in a current frame, the method searches a target block in a previous frame which most matches with the original block, the method generates a motion vector required for encoding the original block according to relative positions of the target block and the original block, the target block is one of a plurality of blocks B(I, J) corresponding to a plurality of points CP(I, J) contained in a search region, and I and J are integers,
the motion estimation method comprising:
(a) setting parameters K=0, L=0, P=1;
(b) setting a P-th main search window, which has a plurality of check points comprising points CP(M, N), wherein M=K+i, N=L+j, i, j=−3, 0, 3, calculating a plurality of block distortion measures BDM(M, N) of the blocks respectively corresponding to the check points of the P-th main search window, and defining a minimum one among the block distortion measures as a BDM(K+s, L+t), wherein s and t are integers;
(c) determining whether P equals a main predetermined number of step, and executing step (f) if yes, otherwise executing step (c1);
(c1) determining whether s=t=0, and executing step (f) if yes, otherwise executing step (d);
(d) adding s to K, adding t to L, adding 1 to P, and executing step (b); and
(f) setting an auxiliary search window, which has a plurality of check points comprising points CP(M′, N′), wherein M′=K+u, N′=L+v, u, v=−1, 0, 1, calculating a plurality of block distortion measures BDM(M′, N′) of the blocks respectively corresponding to the check points of the auxiliary search window, and selecting the block corresponding to a minimum one among the block distortion measures as the target block.

2. The method according to claim 1, wherein the center point CP(0, 0) of the search region corresponds to the block B(0, 0), which has the same position as the original block in the previous frame.

3. The method according to claim 1, wherein the block distortion measure corresponding to a check point is calculated by summing up all of the absolute values of differences between the image data of all pixels of the block in the previous frame corresponding to the check point and the image data of all pixels of the original block.

4. The method according to claim 1, wherein the main predetermined number of step is an integer greater than or equal to 1.

5. The method according to claim 1, wherein the main predetermined number of step equals 3, −10<=I<=10, and −10<=J<=10.

6. The method according to claim 1 being applied for encoding an image signal to be transmitted or to be received by a mobile phone.

7. A motion estimation method for video encoding, wherein when encoding an original block in a current frame, the method generates a motion vector required for encoding the original block,
the method comprising:
(a0) generating a center point;
(a) executing a first step of search operation having a step size of 3, wherein a first main search window having 7×7 points is generated around the center point, a plurality of block distortion measures respectively corresponding to a plurality of check points in the first main search window are calculated, and the check point corresponding to a minimum one among the block distortion measures is set as a candidate check point;
(a1) determining whether the candidate check point set in (a) is the center point of the first main search window, and executing step (c) if yes, otherwise executing step (b);
(b) executing a second step of search operation having a step size of 3, wherein a second main search window having 7×7 points is generated around the candidate check point set in (a), a plurality of block distortion measures respectively corresponding to a plurality of check points in the second main search window are calculated, and the check point corresponding to a minimum one among the block distortion measures in the second step of search operation is set as the candidate check point;
(b1) determining whether the candidate check point set in (b) is the center point of the second main search window, and executing step (c) if yes, otherwise executing step (b2);
(b2) executing a third step of search operation having a step size of 3, wherein a third main search window having 7×7 points is generated around the candidate check point set in (b), a plurality of block distortion measures respectively corresponding to a plurality of check points of the third main search window are calculated, and the check point corresponding to a minimum one among the block distortion measures in the third step of search operation is set as the candidate check point; and
(c) executing a last step of search operation having a step size of 1, wherein an auxiliary search window having 3×3 points is generated around the candidate check point set in (b2), a plurality of block distortion measures respectively corresponding to a plurality of check points in the auxiliary search window are calculated, the check point corresponding to a minimum one among the block distortion measures in the last step of search operation is set as the candidate check point, and the motion vector is obtained according to the set candidate check point and the center point generated in (a0).

8. The method according to claim 7, wherein the block distortion measure corresponding to a check point is calculated by summing up all of the absolute values of differences between the image data of all pixels of the block in the previous frame corresponding to the check point and the image data of all pixels of the original block.

9. The method according to claim 7 being applied for encoding an image signal to be transmitted or to be received by a mobile phone.

10. A motion estimation method for video encoding, wherein when encoding an original block in a current frame, the method searches a target block in a previous frame which most matches with the original block, the method generates a motion vector required for encoding the original block according to relative positions of the target block and the original block, the target block is one of a plurality of blocks B(I, J) corresponding to a plurality of points CP(I, J) contained in a search region, and I and J are integers,
the motion estimation method comprising:
(a) setting parameters K=0, L=0, P=1;
(b) setting a P-th main search window, which has a plurality of check points comprising points CP(M, N), wherein M=K+i, N=L+j, i, j=−3, 0, 3, calculating a plurality of block distortion measures BDM(M, N) of the blocks respectively corresponding to the check points of the P-th main search window, and defining a minimum one among the block distortion measures as a BDM(K+s, L+t), wherein s and t are integers;
(c) determining whether P equals a main predetermined number of step, and executing step (f) if yes, otherwise executing step (d);
(d) adding s to K, adding t to L, adding 1 to P, and executing step (b); and
(f) setting an auxiliary search window, which has a plurality of check points comprising points CP(M′, N′), wherein M′=K+u, N′=L+v, u, v=−1, 0, 1, calculating a plurality of block distortion measures BDM(M′, N′) of the blocks respectively corresponding to the check points of the auxiliary search window, and selecting the block corresponding to a minimum one among the block distortion measures as the target block.

11. The method according to claim 10, wherein the center point CP(0, 0) of the search region corresponds to the block B(0, 0), which has the same position as the original block in the previous frame.

12. The method according to claim 10, wherein the block distortion measure corresponding to a check point is calculated by summing up all of the absolute values of differences between the image data of all pixels of the block in the previous frame corresponding to the check point and the image data of all pixels of the original block.

13. The method according to claim 10 being applied for encoding an image signal to be transmitted or to be received by a mobile phone.

14. An electronic apparatus, comprising:
a memory for storing a program; and
a processor for executing the program so as to perform the method of claim 1.

15. The apparatus according to claim 14 being a mobile phone.

16. The apparatus according to claim 14, wherein the center point CP(0, 0) of the search region corresponds to the block B(0, 0), which has the same position as the original block in the previous frame.

17. The apparatus according to claim 14, wherein the block distortion measure corresponding to a check point is calculated by summing up all of the absolute values of differences between the image data of all pixels of the block in the previous frame corresponding to the check point and the image data of all pixels of the original block.

18. The apparatus according to claim 14, wherein the main predetermined number of step is an integer greater than or equal to 1.

19. The apparatus according to claim 14, wherein the main predetermined number of step equals 3, −10<=I<=10, and −10<=J<=10.

20. An electronic apparatus, comprising:
a memory for storing a program; and
a processor for executing the program so as to perform the method of claim 7.

21. The apparatus according to claim 20 being a mobile phone.

22. The apparatus according to claim 20, wherein the block distortion measure corresponding to a check point is calculated by summing up all of the absolute values of differences between the image data of all pixels of the block in the previous frame corresponding to the check point and the image data of all pixels of the original block.

23. An electronic apparatus, comprising:
a memory for storing a program; and
a processor for executing the program so as to perform the method of claim 10.

24. The apparatus according to claim 23 being a mobile phone.

25. The apparatus according to claim 23, wherein the center point CP(0, 0) of the search region corresponds to the block B(0, 0), which has the same position as the original block in the previous frame.

26. The apparatus according to claim 23, wherein the block distortion measure corresponding to a check point is calculated by summing up all of the absolute values of differences between the image data of all pixels of the block in the previous frame corresponding to the check point and the image data of all pixels of the original block.
